(19) United States
(12) Patent Application Publication
(10) Pub. No.: US 2023/0179014 A1
(43) Pub. Date: Jun. 8, 2023

(54) UNINTERRUPTIBLE POWER SUPPLY WITH BYPASS POWER SHARING FUNCTION

(71) Applicant: SANTAK ELECTRONIC (SHENZHEN) CO., LTD., Shenzhen (CN)

(72) Inventors: YULONG HAO, Shenzhen (CN); YUE YANG, Shenzhen (CN); DAWEI ZHENG, Shenzhen (CN)

(21) Appl. No.: 18/056,216

(22) Filed: Nov. 16, 2022

(30) Foreign Application Priority Data
Nov. 18, 2021 (CN) 202111367102.3

(51) Int. Cl. H02J 9/06; H02J 7/34; H02M 5/40; H02J 7/00

(52) U.S. Cl. CPC H02J 9/068; H02J 7/0031; H02J 7/0063; H02J 7/342; H02J 9/062; H02M 5/40

(57) ABSTRACT

The present invention provides an uninterruptible power supply with bypass power sharing function, including: an input end, configured to be connected to mains; an output end, configured to be connected to a load; a current sensor, disposed at the output end and configured to sense an output current of the uninterruptible power supply; a bypass branch, disposed between the input end and the output end; and an inverter branch, including a rectifier, an inverter and an energy storage battery, wherein one end of the rectifier is connected to the input end, and the other end is connected to one end of the inverter; the other end of the inverter is connected to the output end; and the energy storage battery is connected to a node between the rectifier and the inverter, wherein the uninterruptible power supply is set to be capable of working in a mains mode; and in the mains mode, the inverter branch is controlled with a current loop, so that the bypass branch and the inverter branch together provide the output current of the uninterruptible power supply.

### TECHNICAL FIELD

The present invention relates to the field of electric power supplies, and in particular, to an uninterruptible power supply with bypass power sharing function.

### BACKGROUND

An uninterruptible power supply (UPS) is a power supply device that provides a load with an uninterruptible, high-quality and reliable alternating current and has functions of conducting real-time protection and monitoring a power supply status. The UPS plays an important role in improving the power supply quality and ensuring normal running of the device. The UPS mainly includes a rectifier, an inverter, a charger, and a bypass branch. When the mains is normally input, the charger stores electrical energy for a storage device such as a battery. When the mains is interrupted, the UPS immediately switches to a battery mode for continuous running. However, when the UPS is faulty, the UPS switches to the bypass branch to continue to supply power to the load, so that uninterrupted power supply can be implemented.

Generally, the bypass branch and an inverter branch of the UPS cannot work simultaneously. This is because both the bypass branch and the inverter branch use voltage sources; and if the two branches work simultaneously, an uncontrollable heavy current between the two branches is caused, resulting in a damage to the UPS. To save energy, more users choose to use, for example, an energy save system (ESS) mode UPS of Eaton Corporation, to supply power through the bypass branch, and then the UPS switches to the inverter branch when it is required. In this case, if the inverter branch is completely disconnected when the bypass branch works, the inverter branch cannot store energy for the battery, and long switching time of about 4 to 10 ms is required in a process of switching from the bypass branch to the inverter branch. In addition, respective overload capabilities of the bypass branch and the inverter branch are also limited.

### SUMMARY

Therefore, an objective of the present invention is to overcome the above defects of the conventional technology, and provide an uninterruptible power supply with bypass power sharing function, including:
an input end, configured to be connected to mains;
an output end, configured to be connected to a load;
a current sensor, disposed on the output end and configured to sense an output current of the uninterruptible power supply;
a bypass branch, disposed between the input end and the output end; and
an inverter branch, including a rectifier, an inverter, and an energy storage battery, wherein one end of the rectifier is connected to the input end, and the other end of the rectifier is connected to one end of the inverter; the other end of the inverter is connected to the output end, and the energy storage battery is connected to a node between the rectifier and the inverter,
wherein, the uninterruptible power supply is set to be capable of working in a mains mode; and in the mains mode, the inverter branch is controlled with a current loop, so that the bypass branch and the inverter branch together provide the output current of the uninterruptible power supply, wherein the output current of the uninterruptible power supply sensed by the current sensor is fed back to an input end of the inverter, and the inverter adjusts an output current of the inverter branch based on the feedback current, so that a sum of the output current of the inverter branch and an output current of the bypass branch meets a preset value.

According to the uninterruptible power supply in the present invention, preferably, if the output current of the inverter branch is less than the preset value, the bypass branch provides a forward current to supplement the output current of the inverter branch.

According to the uninterruptible power supply in the present invention, preferably, if the output current of the inverter branch is greater than the preset value, the bypass branch provides a reverse current to release excess electrical energy.

According to the uninterruptible power supply in the present invention, preferably, the uninterruptible power supply is set to be capable of working in a battery mode when the mains is faulty, wherein the output current of the uninterruptible power supply is provided by using the energy storage battery.

According to the uninterruptible power supply in the present invention, preferably, the uninterruptible power supply is set to be capable of working in a bypass mode when the inverter branch is faulty, wherein the output current of the uninterruptible power supply is provided through the bypass branch by using the mains.

According to the uninterruptible power supply in the present invention, preferably, the energy storage battery includes a rechargeable battery.

According to the uninterruptible power supply in the present invention, preferably, the energy storage battery further includes a new energy battery connected in parallel to the rechargeable battery.

According to the uninterruptible power supply in the present invention, preferably, the inverter branch further includes a first DC/DC converter configured to be connected between the energy storage battery and the inverter.

According to the uninterruptible power supply in the present invention, preferably, the inverter branch further includes an energy storage power module, one end of the energy storage power module is connected to the energy storage battery, and the other end is configured to be connected to a power grid and used for providing electrical energy of the energy storage battery for the power grid.

According to the uninterruptible power supply in the present invention, preferably, the mains mode includes:
an off-peak power consumption mode, wherein the energy storage battery is charged with the mains; and
a peak power consumption mode, wherein the energy storage battery supplies the power to the power grid by using the energy storage power module.

According to the uninterruptible power supply in the present invention, preferably, the power grid includes the load; and in the peak power consumption mode, the energy storage battery and the mains are together used for supplying the power to the load.

According to the uninterruptible power supply in the present invention, preferably, the energy storage power module includes a current converter and a second DC/DC converter; one end of the current converter is configured to be connected to the power grid, and the other end of the current converter is connected to one end of the second DC/DC converter; and the other end of the second DC/DC converter is connected to the energy storage battery.

Compared with the conventional technology, the UPS with bypass power sharing function in the present invention has a strong loading capacity, short bypass switching time and high battery utilization, and saves power resources.

### BRIEF DESCRIPTION OF THE DRAWINGS

Embodiments of the present invention are further described with reference to the accompany drawings, wherein:

FIG. 1 is a schematic diagram of a circuit topology of a UPS with bypass power sharing function according to a first embodiment of the present invention;

FIG. 2 is a schematic diagram of a circuit topology of a UPS with bypass power sharing function according to a second embodiment of the present invention; and

FIG. 3 is a schematic diagram of a circuit topology of a UPS with bypass power sharing function according to a third embodiment of the present invention.

### DETAILED DESCRIPTION

To make objectives, technical solutions, and advantages of the present invention clearer, the present invention will be further described in detail by the specific embodiments with reference to the accompanying drawings in the following. It should be understood that specific embodiments described herein are merely intended to explain the present invention, but are not intended to limit the present invention.

### First Embodiment

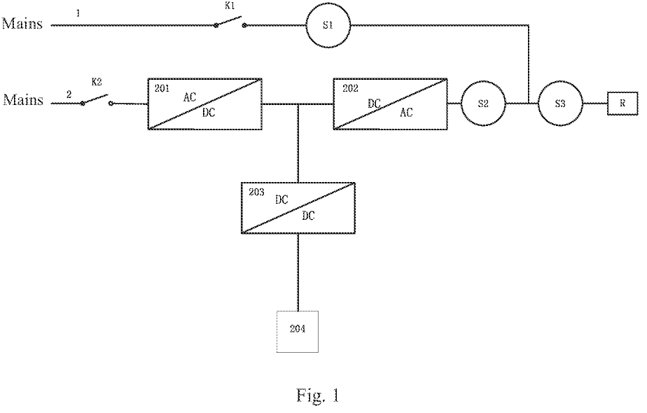

The first embodiment of the present invention provides a UPS with bypass power sharing function. Refer to a schematic diagram of a circuit topology of the UPS with bypass power sharing function according to the first embodiment shown in FIG. 1. The UPS includes a bypass branch 1 and an inverter branch 2.

The bypass branch 1 includes a bypass switch K1, and preferably, further includes a bypass current sensor S1 connected in series to the bypass switch K1.

The inverter branch 2 includes an inverter switch K2, a rectifier 201, an inverter 202, a DC/DC converter 203, a rechargeable battery 204, and optionally, an inverter current sensor S2. An output end of the rechargeable battery 204 is connected to a node between the rectifier 201 and the inverter 202 by using the DC/DC converter 203. The inverter current sensor S2 is connected to an output end of the inverter 202. The bypass switch K1 and the inverter switch K2 are respectively configured to control conduction and disconnection of the bypass branch 1 and the inverter branch 2. In the present invention, the bypass branch 1 and the inverter branch 2 together provide an output current of the uninterruptible power supply for a load R to supply power. An output current sensor S3 is configured to monitor the output current of the uninterruptible power supply, that is, an input current Iᵢ of the load R. A current loop is employed to control an output current of the inverter branch 2, so that a sum of the current of the inverter branch and a current of the bypass branch meets a preset value, wherein the preset value is determined based on a current value required by the load R. The current loop refers to a current feedback system, which generally refers to a method of accessing the output current to a processing stage in a positive or negative feedback manner. In the present invention, the output current sensor S3 senses the output current of the uninterruptible power supply and feeds back the output current to an input end of the inverter 202. The inverter 202 adjusts the output current of the inverter branch based on the feedback current. In the present invention, if a current of the load is I_{R}, the output current of the inverter branch is Iᵢ, and the output current of the bypass branch is I_{b}, Iᵢ+I_{b}=I_{R}, wherein if I_{R}>Iᵢ, I_{b} is positive, and the bypass branch provides a forward current to the load to supply the power; and if I_{R}<Iᵢ, I_{b} is negative, and the bypass branch provides a reserve current to discharge a power grid. A person skilled in the art should understand that the bypass current cannot exceed a rated current of the bypass branch, and the inverter current cannot exceed a rated current of the inverter branch. A working mode of the UPS with bypass power sharing function in the first embodiment is as follows.

### Mains Mode

The mains supplies power to the load R through both the bypass branch 1 and the inverter branch 2. In one aspect, the mains provides a first current for the load R through the bypass branch 1, and as described above, the first current may be positive or negative. In another aspect, the rectifier 201 converts alternating current input of the mains to direct current output, and the inverter 202 converts direct current output of the rectifier 201 to stable alternating current output, to provide a second current for the load R. At the same time, the DC/DC converter 203 serves as a charger, which receives the direct current output from the rectifier 201, to charge the rechargeable battery 204.

### Battery Mode

When the mains is faulty, the rechargeable battery 204 independently supplies the power to the load R. In this case, the DC/DC converter 203 converts an unstable direct current that is from the rechargeable battery 204 to stable direct current output, and then the inverter 202 converts the direct current output to alternating current output, so as to provide the alternating current output for the load R.

### Bypass Mode

When the inverter branch 2 is faulty, the mains directly supplies the power to the load R through the bypass branch 1.

In the UPS with bypass power sharing function of this embodiment, the bypass branch 1 and the inverter branch 2 together supply the power to the load R. In one aspect, this significantly improves a loading capability of the UPS, and even can continuously support up to 200% overload. In another aspect, excess power can be released to the power grid through the bypass branch 1, which improves the applicability of the UPS. In addition, when the inverter branch 2 of the UPS is faulty, the bypass branch 1 continues to supply the power to the load, and switching between the inverter branch and the bypass branch is not needed, that is, a switching time is zero.

### Second Embodiment

The second embodiment provides another UPS with bypass power sharing function. A rechargeable battery 204 may serve as an auxiliary power supply device to supply power to a power grid, so as to improve battery utilization and avoid resource wastes. The power grid may be mains, an internal power grid, or another load network requiring power supply.

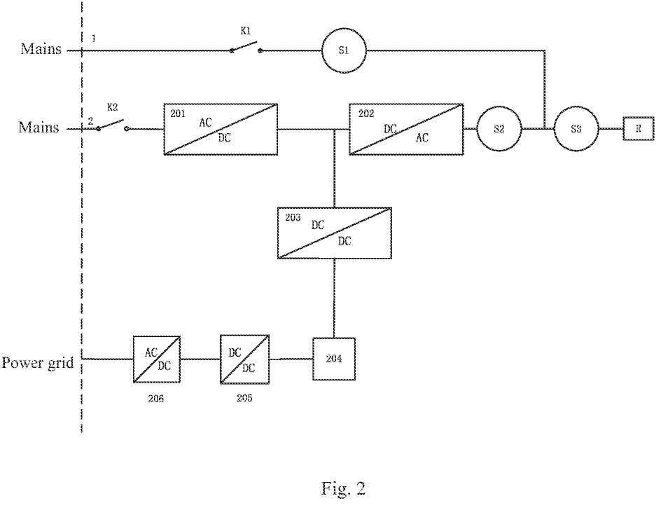

Refer to a schematic diagram of a circuit topology of the UPS with bypass power sharing function according to the second embodiment shown in FIG. 2. The UPS includes a bypass branch 1 and an inverter branch 2. The specific circuit topology is the same as the circuit topology in the first embodiment, and the difference lies in that the rechargeable battery 204 is further connected to the power grid through an energy storage power module. The energy storage power module includes a DC/DC converter 205 and a current converter 206. An alternating current end of the current converter 206 is connected to the power grid, a direct current end is connected to one end of the DC/DC converter 205, and the other end of the DC/DC converter 205 is connected to the rechargeable battery 204. In this embodiment, the current converter 206 performs two-way conversion, and can either convert an alternating current to a direct current (AC-DC conversion, which is a rectification function) or convert a direct current to an alternating current (DC-AC conversion, which is an inverter function).

When the energy storage power module supplies the power to an external power grid, the rechargeable battery 204 transmits a direct current to the DC/DC converter 205, the DC/DC converter 205 converts the unstable direct current that is from the rechargeable battery 204 to a stable direct current voltage and outputs the direct current voltage to the current converter 206; and the current converter 206 converts the direct current voltage to an alternating current and outputs the alternating current to the power grid. The power grid may also charge the rechargeable battery 204. The current converter 206 converts the alternating current that is from the power grid to a direct current and outputs the direct current to the DC/DC converter 205. The DC/DC converter 205 converts the direct current to a stable direct current voltage and outputs the direct current voltage to the rechargeable battery 205, to charge the rechargeable battery 205.

Similarly, in this embodiment, the bypass branch 1 and the inverter branch 2 together provide an output current of the uninterruptible power supply to supply the power to a load R. A current loop is employed to control an output current of the inverter branch 2, so that a sum of the current of the inverter branch and a current of the bypass branch meets a preset value. A working mode of the UPS with bypass power sharing function of the second embodiment is as follows.

### Mains Mode

Off-peak power consumption (such as at night): The mains supplies the power to the load R through both the bypass branch 1 and the inverter branch 2. In one aspect, the mains provides a first current for the load R through the bypass branch 1, and similarly, the first current may be positive or negative. In another aspect, a rectifier 201 converts alternating current input of the mains to direct current output, and an inverter 202 converts the direct current output of the rectifier 201 to stable alternating current output, so as to provide a second current for the load R. At the same time, the DC/DC converter 203 serves as a charger, which receives the direct current output from the rectifier 201, to charge the rechargeable battery 204.

Peak power consumption (such as during the day): The rechargeable battery 204 serves as an auxiliary power supply to supply the power to the power grid through the energy storage power module. Specifically, the direct current output by the rechargeable battery 204 is converted to a stable direct current voltage through the DC/DC converter 205 and output to the current converter 206, and the current converter 206 converts the direct current voltage to an alternating current and outputs the alternating current to the power grid, so as to avoid battery from being in an idle state and improve battery utilization. Optionally, the rechargeable battery 204 may further be used for simultaneously supplying the power to the load and the power grid, and a controller may be used for controlling and allocating voltages for supplying the power to the load and the power grid. Particularly, the rechargeable battery 204 serves as an auxiliary power supply to supply the power to the load R. Specifically, in one aspect, the mains provides a first current for the load R through the bypass branch 1. In another aspect, the rectifier 201 converts alternating current input of the mains to direct current output, to provide a first direct current for the inverter 202. At the same time, the rechargeable battery 204 provides a second direct current for the inverter 202 through the DC/DC converter 203, and the inverter 202 converts a sum of the first direct current and the second direct current to stable alternating output, so as to provide a second current for the load R.

### Battery Mode

When the mains is faulty, the rechargeable battery 204 independently supplies the power to the load R. In this case, the DC/DC converter 203 converts the unstable direct current that is from the rechargeable battery 204 to stable direct current output, and then the inverter 202 converts the direct current output to alternating current output, so as to provide the alternating current output for the load R.

### Bypass Mode

When the inverter branch 2 is faulty, the mains directly supplies the power to the load R through the bypass branch 1.

In the UPS with bypass power sharing function of this embodiment, the bypass branch 1 and the inverter branch 2 together supply the power to the load R. This significantly improves a loading capability of the UPS, and improves the applicability of the UPS. In addition, when the inverter branch 2 of the UPS is faulty, the bypass branch 1 continues to supply the power to the load, and switching between the inverter branch and bypass branch is not needed, that is, a switching time is zero. In addition, the rechargeable battery 204 of the UPS with bypass power sharing function of this embodiment may adjust, according to a requirement or in real time, a peak and off-peak power consumption state based on an input-output power and a power grid load, feed back to the power grid at the peak power consumption, and charge at the off-peak power consumption, so as to implement cross-peak adjustment of the internal power grid, which is adjustment of the internal demand and can avoid the island effect.

### Third Embodiment

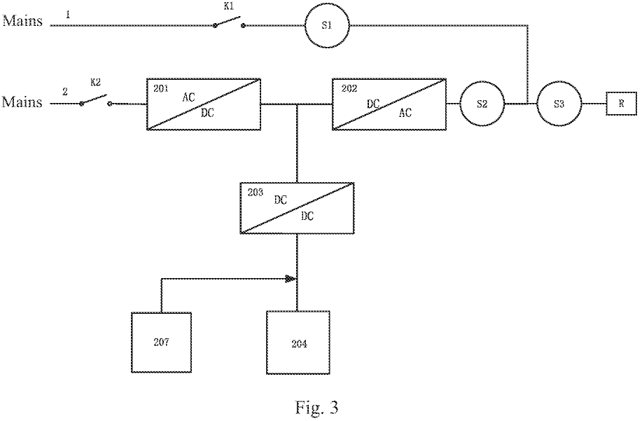

The third embodiment of the present invention provides another UPS with bypass power sharing function. Refer to a schematic diagram of a circuit topology of the UPS with bypass power sharing function according to the third embodiment shown in FIG. 3. The topology structure and a working mode of the UPS is basically the same as the UPS with bypass power sharing function of the first embodiment, and the difference lies in that a rechargeable battery 204 and a new energy battery 207 are connected in parallel to form an energy storage battery, to together serve as a battery component of the UPS. The new energy battery 207 is, for example, a solar battery. In this embodiment, when mains is faulty, the rechargeable battery 204 and the new energy battery 207 together supply power to a load R. In this case, a DC/DC converter 203 converts unstable direct currents that are from the rechargeable battery 204 and the new energy battery 207 to stable direct current output, and then an inverter 202 converts the direct current output to alternating current output, so as to provide the alternating current output for the load R. In this way, through the supplement of new energy, the power resources are saved.

According to other embodiments, output of the new energy battery 207 is provided for the load R after being directly converted by using the inverter 202, and DC/DC conversion is not needed. In addition, it should be noted that in the present invention, the DC/DC converter is mainly configured to output a stable voltage and perform voltage matching. If output of the rechargeable battery is natively stable enough and an output voltage of the rechargeable battery is matched with the load or a power grid, the DC/DC converter can be omitted.

According to other embodiments, the new energy battery 207 and the rechargeable battery 204 are together connected to the power grid by using an energy storage power module. This can be seen as a further improvement of the UPS with bypass power sharing function in the second embodiment, uses the new energy on the basis of improved battery utilization, and further avoids resource wastes.

The UPS with bypass power sharing function of the present invention significantly improves the loading capacity of the UPS, eliminates a bypass switching time, improves battery utilization, and saves power resources.

Although the present invention has been described by preferred embodiments, the present invention is not limited to embodiments described herein and includes various changes and variations made without departing from the scope of the present invention.

1. An uninterruptible power supply with bypass power sharing function, comprising:
an input configured to be connected to mains;
an output configured to be connected to a load;
a current sensor configured to sense an output current at the output;
a bypass branch connecting the input and the output;
a rectifier having a first terminal connected to the input;
an inverter having a first terminal connected to a second terminal of the rectifier and a second terminal connected to the output;
an energy storage device connected to a node connected to a node between the rectifier and the inverter,
wherein the bypass branch and the inverter provide the output current in a first mode, wherein the inverter adjusts a current produced by the inverter based on the output current sensed by the current sensor.

2. The uninterruptible power supply according to claim 1, wherein if the current produced by the inverter is less than the preset value, the bypass branch provides a forward current to supplement the current produced by the inverter.

3. The uninterruptible power supply according to claim 1, wherein if the current produced by the inverter is greater than the preset value, the bypass branch provides a reverse current to release excess electrical energy.

4. The uninterruptible power supply according to claim 1, wherein the uninterruptible power supply supports a battery mode when the power source is faulty, wherein the output current of the uninterruptible power supply is provided by using the energy storage battery.

5. The uninterruptible power supply according to claim 1, wherein the uninterruptible power supply supports a bypass mode wherein the output current of the uninterruptible power supply is provided through the bypass branch.

6. The uninterruptible power supply according to claim 1, wherein the energy storage battery comprises a rechargeable battery.

7. The uninterruptible power supply according to claim 6, wherein the energy storage battery further comprises a new energy battery connected in parallel to the rechargeable battery.

8. The uninterruptible power supply according to claim 1, further comprising a first DC/DC converter configured to be connected between the energy storage battery and the inverter.

9. The uninterruptible power supply according to claim 1 further comprising an energy storage power module having a first terminal connected to the energy storage battery and a second terminal configured to be connected to a power grid and used for providing electrical energy of the energy storage battery for the power grid.

10. The uninterruptible power supply according to claim 9, wherein the first mode comprises:
an off-peak power consumption mode, wherein the energy storage battery is charged from the power source; and
a peak power consumption mode, wherein the energy storage battery supplies power to the power grid by using the energy storage power module.

11. The uninterruptible power supply according to claim 10, wherein in the peak power consumption mode, the energy storage battery and the mains are together used for supplying the power to the load.

12. The uninterruptible power supply according to claim 11, wherein the energy storage power module comprises a current converter and a second DC/DC converter, a first terminal of the current converter is configured to be connected to the power source, a second terminal of the current converter is connected to a first terminal of the second DC/DC converter, and a second terminal of the second DC/DC converter is connected to the energy storage battery.
